(19) United States
(12) Patent Application Publication
(10) Pub. No.: US 2010/0033033 A1
(43) Pub. Date: Feb. 11, 2010

(54) ROTATING ELECTRIC MACHINE HAVING REPLACEABLE AND INTERCHANGEABLE CHUCK ASSEMBLIES

(76) Inventors: Weston C. Johnson, Lexington, KY (US); Richard M. Currie, Cumming, GA (US)

Correspondence Address: LUEDEKA, NEELY & GRAHAM, P.C., P O BOX 1871, KNOXVILLE, TN, 37901, US

(21) Appl. No.: 12/579,808

(22) Filed: Oct. 15, 2009

Related U.S. Application Data
(63) Continuation-in-part of application No. 12/325,638, filed on Dec. 1, 2008, now abandoned.
Application No. 12/325,638 is a continuation of application No. 11/128,823, filed on May 13, 2005, now Pat. No. 7,459,822.

(51) Int. Cl. H02K 37/02; H02K 1/14

(52) U.S. Cl. 310/46; 310/195

(57) ABSTRACT

An electric machine, such as a switched reluctance motor (SRM), having a stator housing that allows for stator chuck assemblies to be removed and replaced independently of other stator chuck assemblies is described. The stator housing of the electric machine has a plurality of slots for receiving the stator chuck assemblies and for supporting the chuck assemblies in fixed positions relative to a rotor assembly of the electric machine. In preferred embodiments, the slots are disposed on the exterior surface of the stator housing.

This application is a continuation-in-part of and claims priority to co-pending U.S. patent application Ser. No. 12/325,638 entitled ROTATING ELECTRIC MACHINE HAVING SWITCHED OR VARIABLE RELUCTANCE WITH FLUX TRANSVERSE TO THE AXIS OF ROTATION filed Dec. 1, 2008, which is a continuation of and claims priority to U.S. patent application Ser. No. 11/128,823 entitled ROTATING ELECTRIC MACHINE HAVING SWITCHED OR VARIABLE RELUCTANCE WITH FLUX TRANSVERSE TO THE AXIS OF ROTATION filed May 13, 2005, which issued as U.S. Pat. No. 7,459,822 on Dec. 2, 2008. The entire contents of the above-listed prior applications are incorporated herein by reference.

### FIELD

This invention relates to the field of electric machines, including electric motors and generators. More particularly, this invention relates to switched and variable reluctance machines, such as a switched reluctance motor (SRM) or generator, or a variable reluctance motor (VRM) or generator, having one or more transverse flux axes.

### BACKGROUND

The conventional switched reluctance motor has been around for well over a century. However, commercial viability and widespread utilization of the SRM has been hindered in recent decades for various reasons including poor control techniques, excessive audible noise, and large torque ripple. Despite these disadvantages, the SRM is of interest due its relatively simple construction and resulting lower cost when compared to other traditional electric motors. Because the traditional reluctance motor only has stator windings, the points of failure can only be the windings and shaft bearings. This provides for higher reliability. Additionally, with sufficient phase count the traditional SRM is able to function in the event of a phase failure as there is no flux linkage between phases to produce back-emf on the failed phase.

The traditional SRM topology, such as shown in FIGS. 17A and 17B, has changed little from its inception. Essentially, the conventional SRM consists of a stator 100 with salient teeth 102a-102b and current carrying windings (not shown) that are used to produce flux in a path that links through rotor teeth 104a-104b and a rotor yoke 106. The rotor yoke 106 and stator yoke 100 of the traditional SRM are additionally used for mechanical integrity and rigidity. The flux linkages generated between the stator and rotor of a traditional switched reluctance motor are designed to link primarily in plane(s) perpendicular to the axis 108 of shaft rotation and in the plane 110 of rotor rotation (i.e. radial gap motors). A similar process occurs for axial gap motors except that the flux linkages generated between the stator and rotor of the traditional SRM link primarily in paths parallel to the axis 108 of shaft rotation and perpendicular to the plane 110 of rotor rotation.

For example, as shown in FIGS. 17A and 17B, the primary flux path 103 of the traditional SRM is through the salient stator teeth 102a, salient rotor teeth 104a, the rotor yoke 106, an opposing salient rotor tooth 104b, an opposing salient stator tooth 102b, the stator yoke 100 and back through the originating stator tooth 102a. This flux path lies within a plane 110 that is perpendicular to the axis 108 of shaft rotation.

A common variation to the reluctance motor design is the stacking of multiple reluctance motors, end to end, along a common shaft, at angular offsets so as to increase the magnitude of the generated torque and reduce torque ripple.

Numerous schemes for increasing the controllability of the traditional reluctance motor have been implemented. These schemes vary from innovative control algorithms to novel tooth designs. In one scheme described in U.S. Pat. No. 6,700,272, the motor runs at high speeds yet produces low shaft revolutions per minute (RPM). This allows for reduced torque ripple and results in a shaft RPM usable by most applications, thereby eliminating the need for a gearbox. This particular method has been accomplished through the introduction of differing flux guidance paths that result in a planetary gear effect between the rotor and stator. Despite this, the overall motor topology and planar torque production method is not different from that of the traditional SRM.

No known prior SRM design schemes have altered the fundamental design of the reluctance motor such that the path of the flux linkage through a rotor tooth is variable with position.

### SUMMARY

The switched or variable reluctance motor of the present invention has a primary flux path passing through the center of a stator chuck, through a pole of the stator chuck, through a rotor tooth, through a complimentary stator chuck, through another rotor tooth, and finally through either the originating chuck pole or a different chuck pole. This flux path lies in planes that may be transverse to (not coinciding with) the plane that is perpendicular to the axis of shaft rotation. While this flux path may include the plane perpendicular to the axis of shaft rotation, this perpendicular plane is not the sole flux path plane. With such a flux path, the motor generates or consumes useful torque with increased use of the volume of the motor, providing for smaller motors and increased energy density.

The flux generated by the present invention links the angular positions of the chuck arrangements. Unlike in prior art SRM designs, the predominate flux flow in the present invention is not through the main rotor yoke or stator body. Instead, flux is predominately guided within the respective rotor teeth and stator chucks. In transferring the flux path and the resulting torque to a plane that is transverse to the axis of shaft rotation and independent of the respective yokes, the motor windings are made accessible for easy removal and replacement during motor maintenance.

A preferred embodiment of the invention provides an electric machine comprising a rotor assembly and one or more stator chuck arrangements disposed around and adjacent the rotor assembly. The rotor assembly includes a rotor hub and a plurality of rotor teeth. The rotor hub is disposed in a rotational plane that is substantially perpendicular to the rotational axis. The rotor teeth are affixed to the rotor hub and are disposed in a substantially circular path about the rotational axis. The rotor teeth include at least a first rotor tooth, a second rotor tooth and a third rotor tooth. Each stator chuck arrangement comprises multiple stator chuck sets including a first stator chuck set and a second stator chuck set. Each stator chuck set includes a first stator chuck and an opposing second stator chuck. The first and second stator chucks each have a first chuck pole, a second chuck pole and a chuck winding, where the first and second chuck poles are disposed adjacent the rotor teeth as the rotor assembly rotates about the rotational axis.

During operation of this preferred embodiment of the electric machine, a flux path passes from the first chuck pole of the first chuck of the first stator chuck set into the first rotor tooth, through the first rotor tooth and into the first chuck pole of the second stator chuck of the first stator chuck set. The flux path further passes from the first chuck pole of the second stator chuck of the first stator chuck set to the second chuck pole of the second stator chuck of the first stator chuck set, and from the second chuck pole of the second stator chuck of the first stator chuck set into the second rotor tooth.

During operation of one preferred embodiment, the flux path also passes through the second rotor tooth and into the second chuck pole of the first stator chuck of the first stator chuck set, and from the second chuck pole of the first stator chuck of the first stator chuck set to the first chuck pole of the first stator chuck of the first stator chuck set.

During operation of another preferred embodiment, the flux path also passes through the second rotor tooth and into the second chuck pole of a first stator chuck of the second stator chuck set, from the second chuck pole of the first stator chuck of the second stator chuck set to the first chuck pole of the first stator chuck of the second stator chuck set, and from the first chuck pole of the first stator chuck of the second stator chuck set into the third rotor tooth.

In some preferred embodiments, the stator chuck sets of one or more of the stator chuck arrangements are disposed in a substantially cylindrical relationship about the axis of rotation. In some embodiments, the stator chuck sets of one or more of the stator chuck arrangements are disposed in a substantially conical relationship about the axis of rotation.

In some embodiments, multiple-layer or tiered rotor tooth arrangements and flux paths are possible. Thus the rotor hub may hold more than one set and/or layers of rotor teeth, thereby giving rise to increased stator chuck arrangements and potentially complex flux paths. Additionally, stacking multiple embodiments of the invention end-to-end is possible as is typically done with existing SRM configurations.

In another aspect, the invention provides an electric machine that includes a rotor assembly comprising a plurality of rotor teeth disposed at least partially within the rotational plane and substantially in a circular path centered on the rotational axis of the machine. The electric machine also includes multiple stator chuck sets that each include a first stator chuck and a second stator chuck. The first stator chuck of each stator chuck set is disposed on an opposite side of the rotational plane from the second stator chuck. During operation of the electric machine, a portion of a flux path passes from the first stator chuck through a rotor tooth to the opposing second stator chuck.

In yet another aspect, the invention provides an electric machine comprising a rotor assembly, multiple stator chuck sets and a stator housing. The rotor assembly comprises a plurality of rotor teeth disposed at least partially within the rotational plane of the machine and substantially in a circular path centered on the rotational axis of the machine. Each stator chuck set comprises a first stator chuck and a second stator chuck disposed on opposite sides of the rotational plane from each other. The stator housing supports the stator chucks in fixed positions relative to the rotor assembly in such a manner that each stator chuck may be removed from the stator housing independently of each of the other stator chucks.

In general, the basic theory and analysis of the SRM of the present invention are similar to that of conventional SRM's. However, the revolved windings and other aspects of the invention provide better use of the three dimensional space thereby providing increased energy density. With increased energy density, the invention provides a motor that may be smaller and lighter in weight while still providing power and torque equivalent to much larger conventional motors.

Another advantage of the present invention is that it allows for enhanced maintainability of the motor. In the preferred embodiment, individual stator chucks/windings may be easily removed and replaced, thereby eliminating the necessity of completely rewinding the whole motor. Thus, repairs may be done with the motor in its operational position, thereby avoiding a long-term interruption in the motor operation. In fact, with sufficient controls and design considerations, it may be possible to repair the motor while it is operating. Motor performance may suffer somewhat during such a repair process, but the motor could continue to operate.

In traditional SRM's, acoustic noise can be a significant problem. One source of acoustic noise is aerodynamic turbulence introduced by the salient teeth moving through the air (windage). In the present invention, turbulence noise is significantly reduced because the aerodynamic profile of the rotor hub/housing can be made to match the profile of the tooth structure.

Another source of acoustic noise in traditional SRM's is planar loading due to high normal forces acting on the stator housing. In the traditional SRM design, during flux rise for each phase these normal forces act on opposing stator pole pairs which tends to “squeeze” the stator housing. During flux decline for each phase, the normal forces acting on the opposing pole pairs are reduced which allows the stator housing to “relax.” This periodic squeezing and relaxing causes the stator housing to vibrate which adds to the acoustic noise. Unlike traditional SRM's, the loading of the stator housing of the present invention is primarily transverse to the plane of rotation so that the induced stresses do not traverse through the entire housing. This localizes the loading on the stator housing, thereby significantly reducing acoustic noise.

Another advantage of the present invention is that non-symmetric pole pairs are possible, (a pseudo half-arrangement or half-phase is possible) which could be used to increase the controllability of the motor during transitions between phases.

Also, the novel topology of the present invention could easily be incorporated into a linear SRM or VRM design. While the arrangements shown in the present invention have been configured such that they encircle a shaft, the transverse nature of torque production could easily be arranged in a linear or three dimensional spline path design.

This novel topology also has relevance to magnetically actuated vibrating equipment. Typically, vibrating equipment utilizes electromagnets to attract magnetically conductive material, either of which may be coupled to a load. The spacing between the electromagnets and magnetically conductive material is typically set prior to operation, and is done so based upon a known load range. Should the load decrease, the electromagnet may produce to much force causing disruption in the application and/or damage from contact between the electromagnet and magnetically conductive material. As this design surrounds and encloses the magnetically conductive material, longer, smoother strokes are possible and would not have to be spaced based upon existing loads.

Although the description of the invention focuses on preferred embodiments of a switched reluctance motor, it will be appreciated that various aspects of the invention also apply to switched reluctance generators as well as variable reluctance motors and generators. Thus, the novel topology of the invention is applicable generally to switched reluctance machines, variable reluctance machines, including motors and generators.

One preferred embodiment of the invention provides an electric machine having a rotational axis. The electric machine includes a rotor assembly, a plurality of stator chuck assemblies, and a stator housing for receiving and supporting the stator chuck assemblies in fixed positions relative to the rotor assembly. The rotor assembly includes a rotor hub disposed in a rotational plane that is substantially perpendicular to the rotational axis and a plurality of rotor teeth affixed to the rotor hub. The rotor teeth are disposed in a substantially circular path about the rotational axis and include at least a first rotor tooth and a second rotor tooth. Each stator chuck assembly includes a first chuck pole, a second chuck pole, and a chuck winding. The plurality of stator chuck assemblies include at least a first stator chuck assembly and a second stator chuck assembly. The stator housing includes a plurality of slots for receiving and supporting the stator chuck assemblies so that the first and second chuck poles of each stator chuck assembly are disposed adjacent the rotor teeth as the rotor assembly rotates about the rotational axis.

During operation of the electric machine, a flux path passes from the first chuck pole of the first stator chuck assembly into the first rotor tooth, through the first rotor tooth and into the first chuck pole of the second stator chuck assembly. The flux path further passes from the first chuck pole of the second stator chuck assembly to the second chuck pole of the second stator chuck assembly and from the second chuck pole of the second stator chuck assembly into the second rotor tooth.

A preferred embodiment of the invention provides an electric machine having a rotational axis. The machine includes a rotor assembly having a plurality of rotor teeth disposed in a substantially circular path about the rotational axis and a plurality of substantially identical and interchangeable stator chuck assemblies disposed adjacent the rotor teeth as the rotor assembly rotates about the rotational axis. A stator housing supports the stator chuck assemblies in fixed positions relative to the rotor assembly, and each of the stator chuck assemblies may be removed from the stator housing independently of each of the other stator chuck assemblies.

In some preferred embodiments, the stator housing includes a plurality of slots disposed in an exterior surface of the stator housing for receiving and supporting the stator chuck assemblies. The stator housing includes a first housing half and a second housing half that is separable from the first housing half, and the first housing half and the second housing half may be substantially identical and interchangeable. Additionally, the stator housing may be formed of a nonmetallic material, such as plastic, ceramic, foam, metal or combinations thereof.

In some embodiments, each stator chuck assembly further includes a chuck cartridge for holding a first chuck pole, a second chuck pole and chuck winding. The chuck cartridge is removably received within a corresponding one of the slots in the stator housing. In another aspect, the stator chuck assemblies include means for determining an operating status of the chuck assembly.

The substantially identical and interchangeable chuck assemblies within each chuck set may be removed and replaced discretely, thereby allowing the motor to be disassembled and repaired in place. Further, since all the chuck assemblies within each chuck set are identical, the motor is less expensive to manufacture, and the number of different types of spare parts to keep in inventory is reduced. Additionally, entire spare motors are not needed—only replacement parts are needed.

### BRIEF DESCRIPTION OF THE DRAWINGS

Further advantages of the invention are made apparent by reference to the detailed description in conjunction with the figures, wherein elements are not to scale so as to more clearly show the details, wherein like reference numbers indicate like elements throughout the several views, and wherein:

FIGS. 1A, 1B and 1C depict a rotor assembly according to a preferred embodiment of the invention;

FIGS. 2A and 2B depict a rotor tooth according to a preferred embodiment of the invention;

FIGS. 3A and 3B depict two configurations of a chuck set with phase windings according to a preferred embodiment of the invention;

FIGS. 4A, 4B, 5A and 5B depict a portion of a stator chuck arrangement surrounding a rotor assembly according to a preferred embodiment of the invention;

FIGS. 6A, 6B and 6C depict a stator chuck arrangement surrounding a rotor assembly according to a preferred embodiment of the invention;

FIGS. 7A, 7B and 7C depict side views of three separate stator chuck arrangements, each surrounding a rotor assembly according to a preferred embodiment of the invention;

FIGS. 8A, 8B and 8C depict perspective views of three separate stator chuck arrangements, each surrounding a rotor assembly according to a preferred embodiment of the invention;

FIGS. 9A and 9B depict side and perspective views of a motor assembly comprising three stator chuck arrangements surrounding a single rotor assembly according to a preferred embodiment of the invention;

FIGS. 10A and 10B depict perspective views of a motor assembly comprising three stator chuck arrangements surrounding a single rotor assembly according to a preferred embodiment of the invention;

FIGS. 11A and 11B depict two views of a chuck arrangement surrounding a rotor assembly to provide a loop flux path according to a preferred embodiment of the invention;

FIGS. 12A and 12B depict two views of a chuck arrangement surrounding a rotor assembly to provide a coupled flux path according to a preferred embodiment of the invention;

FIGS. 13A-13F depict various views of a stator housing according to a preferred embodiment of the invention;

FIG. 14 depicts three chuck arrangements surrounding a rotor assembly to provide a loop flux path according to a preferred embodiment of the invention;

FIG. 15 depicts three chuck arrangements surrounding a rotor assembly to provide a coupled flux path according to a preferred embodiment of the invention;

FIG. 16 depicts rotation of flux direction in a rotor tooth during operation of a switched reluctance machine having three chuck arrangements according to a preferred embodiment of the invention;

FIGS. 17A and 17B depict an example of a conventional switched reluctance motor;

FIG. 18 depicts a stator chuck according to one embodiment of the invention;

FIG. 19 depicts a chuck cartridge according to one embodiment of the invention;

FIG. 20 depicts a stator chuck assembly according to one embodiment of the invention;

FIG. 21 depicts a stator housing with stator chuck assemblies positioned for insertion into slots disposed in the stator housing according to one embodiment of the invention;

FIG. 22 depicts a stator housing with stator chuck assemblies inserted into slots in the housing according to one embodiment of the invention;

FIG. 23 depicts a perspective view of a first half of a stator housing according to one embodiment of the invention;

FIG. 24 depicts a front view of a first half of a stator housing according to one embodiment of the invention;

FIG. 25 depicts a perspective view of a stator housing attached to a base according to one embodiment of the invention; and

FIG. 26 depicts a perspective view of a base for supporting a stator housing according to one embodiment of the invention.

### DETAILED DESCRIPTION

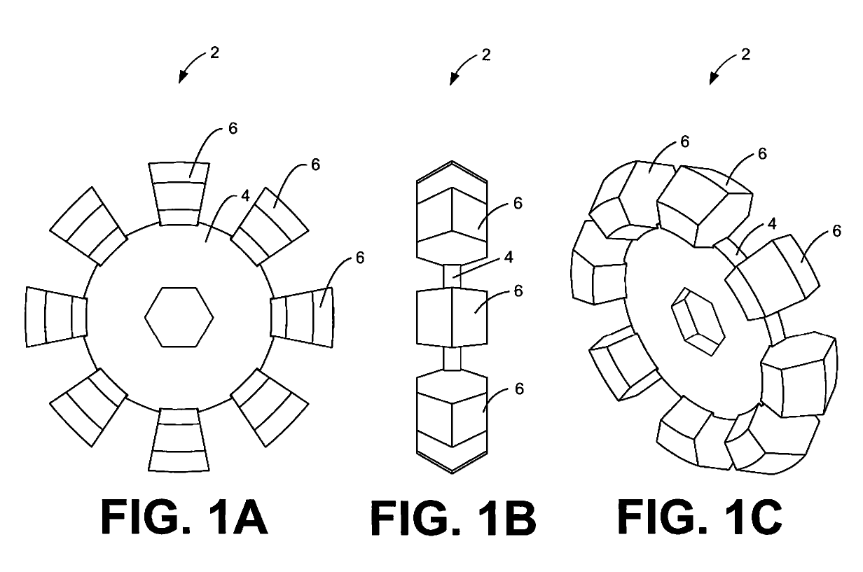

As shown in FIGS. 1A-1C, a preferred embodiment of the invention includes a rotor assembly 2 comprising a rotor hub 4 and multiple rotor teeth 6. The primary purpose of the rotor hub 4 is to hold the rotor teeth 6 and mechanically couple the rotor teeth 6 to a shaft. Because the path of the flux linkage of the preferred embodiment does not coincide with the plane of the rotor hub 4, the rotor hub 4 need not be electrically or magnetically conductive. Thus, the hub 4 may be formed from practically any material that provides the desired structural rigidity, such as, plastic, metal or composite materials. There may be multiple sets of rotor teeth 6 located at various spatial and angular offsets that are held fixed by the one or more rotor hubs 4. Therefore, the invention is not limited to any particular rotor tooth arrangement.

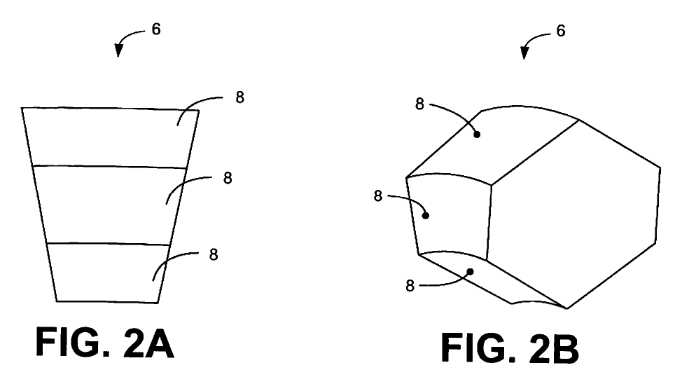

In the present invention, the flux linkages that produce the useful torque are made between a stator and the rotor teeth 6—not through a rotor yoke as is done in conventional SRM's. As shown in FIGS. 1A-1C, the rotor teeth 6 of the present invention are designed such that their spatial and angular offsets are symmetrical. As shown in FIGS. 2A and 2B, each tooth 6 may be described as a segment of a toroid. The outside surface of each rotor tooth 6 has a finite number of faces 8. In an alternative embodiment, the outer surfaces of the rotor teeth 6 are smooth, as with a typical toroidal shape.

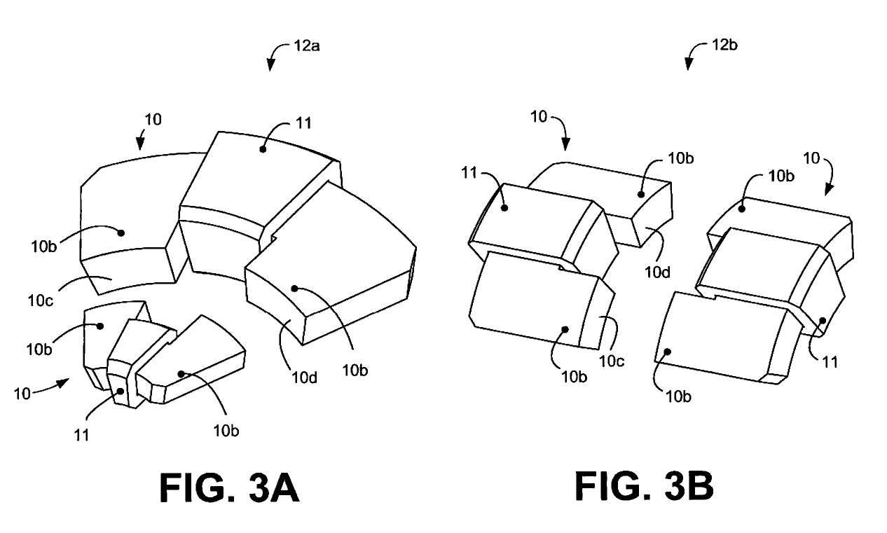

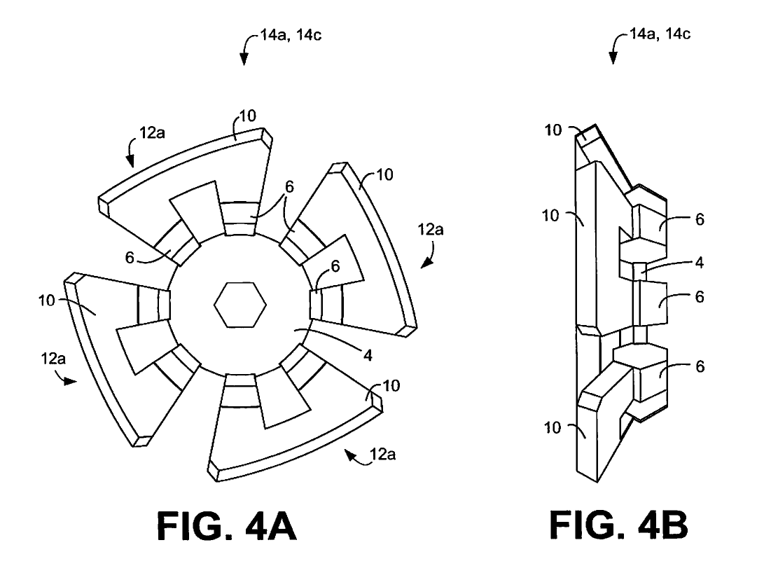

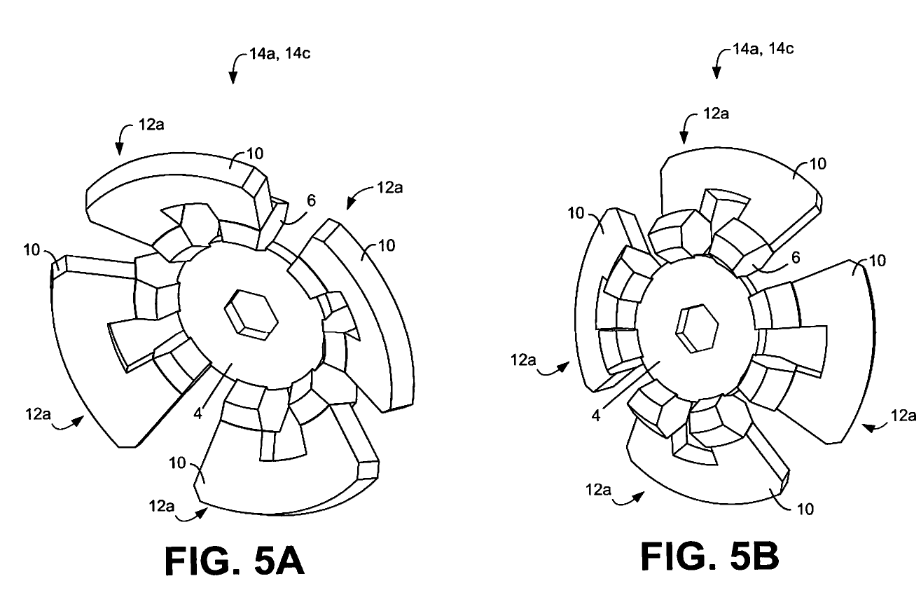

FIGS. 3A-3B depict two configurations of stator chuck sets 12a and 12b which surround the rotor teeth 6. Each stator chuck set 12a, 12b comprises two opposing stator chucks 10. As shown in FIGS. 4A-4B, 5A-5B, 6A-6C, 7A-7C, 8A-8C, 9A-9B and 10A-10B, each of the stator chucks 10 is angularly and spatially offset from the rotor teeth 6 and from each of the other stator chucks 10. As shown in FIGS. 3A and 3B, each chuck 10 preferably includes a chuck center 10a and two chuck poles 10b. About the center 10a of each stator chuck 10 is secured a winding 11 or other flux production means. It will be appreciated that FIGS. 4A-4B and 5A-5B show only the outer (larger) of the chucks 10 of each chuck set 12a.

During operation of the motor, flux linkages develop between one or more chucks 10, through one or more rotor teeth 6, and into one or more opposing chucks 10. Thus, the stator chucks 10 are the primary conduit for the stator flux. The chuck poles 10b are profiled such that each pole has a face 10c-10d that is parallel to a corresponding rotor tooth face 8.

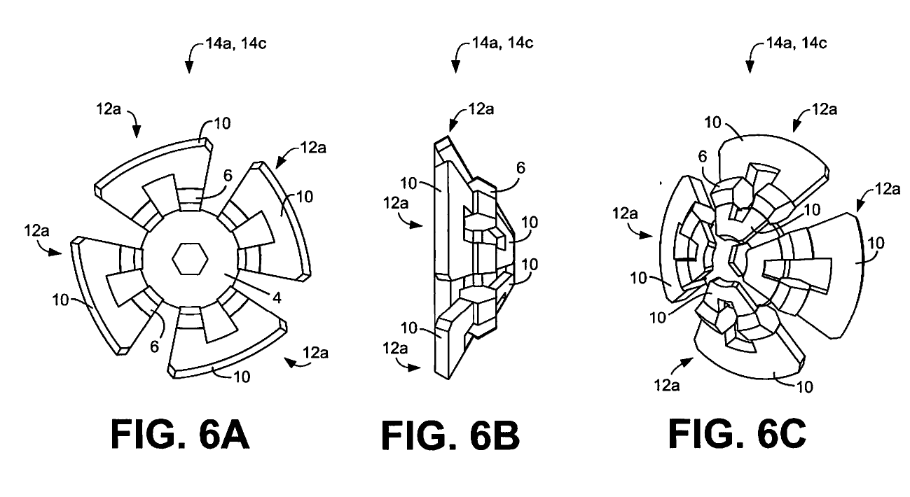

As shown in FIGS. 6A-6C, 7A-7C and 8A-8C, each stator chuck arrangement 14a, 14b, 14c consists of one or more complimentary chuck sets 12a-12b that enclose and surround the rotor teeth 6. Complimentary chuck sets 12a-12b in a chuck arrangement 14a, 14b, 14c need not be in parallel, nor do they need to be symmetrically located about the rotor teeth 6 or to other chucks sets 12a-12b. Additionally, complimentary chuck sets 12 may have an odd or even number of chucks 10.

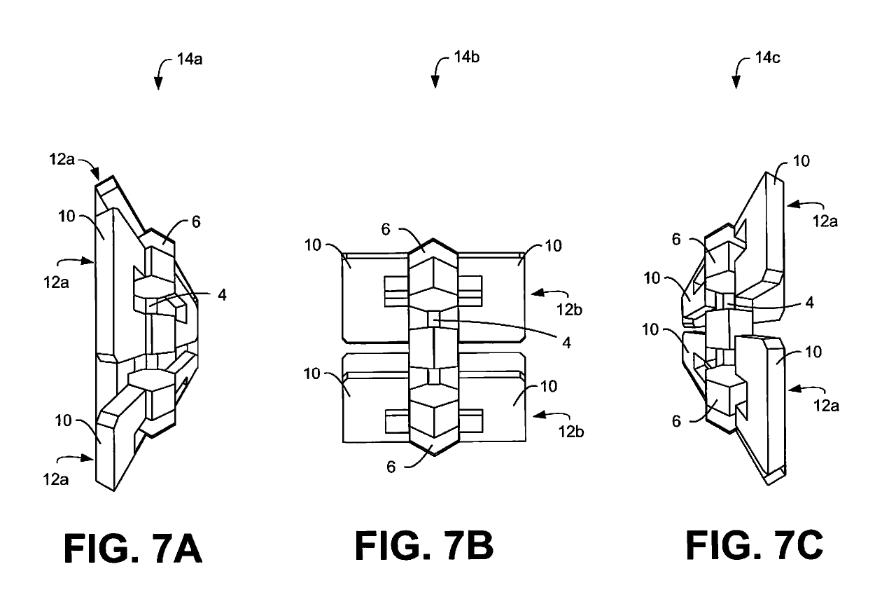

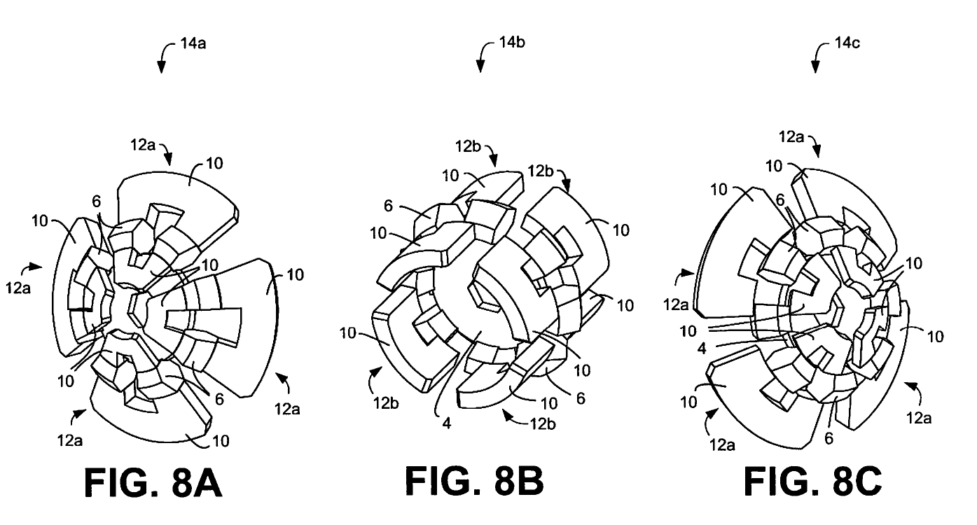

In a preferred embodiment of the invention depicted in FIGS. 7A-7C and 8A-8C, the motor comprises three stator chuck arrangements 14a, 14b, 14c that are angularly offset and spatially offset from each other. The stator chuck arrangements 14a, 14b, 14c may or may not overlap other stator chuck arrangements 14a, 14b, 14c. Should they overlap, then during operation, direct flux linkage paths exist between the rotor teeth 6 and one or more of the stator chuck arrangements 14a, 14b, 14c. In addition, stator chuck arrangements 14 are angularly and spatially positioned such that flux through any stator chuck 10 may link through one or more rotor teeth 6. Although the preferred embodiment of the invention includes three stator chuck arrangements 14a, 14b, 14c, it should be appreciated that there may be more or fewer than three that may or may not overlap. Therefore, the invention is not limited to any particular number of stator chuck arrangements, or angular or spatial offsets.

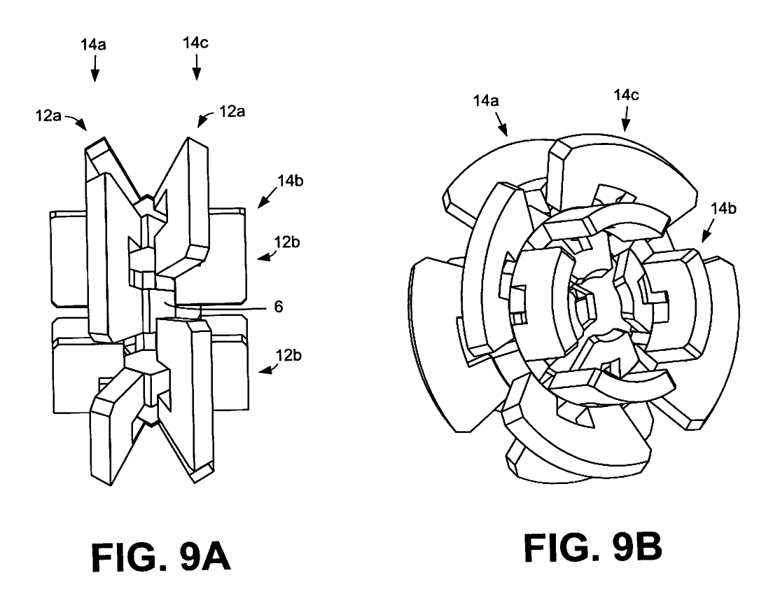

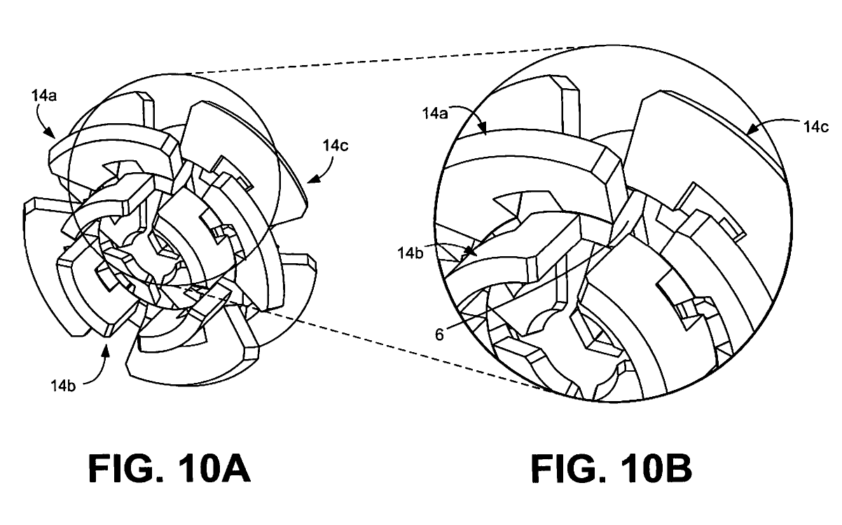

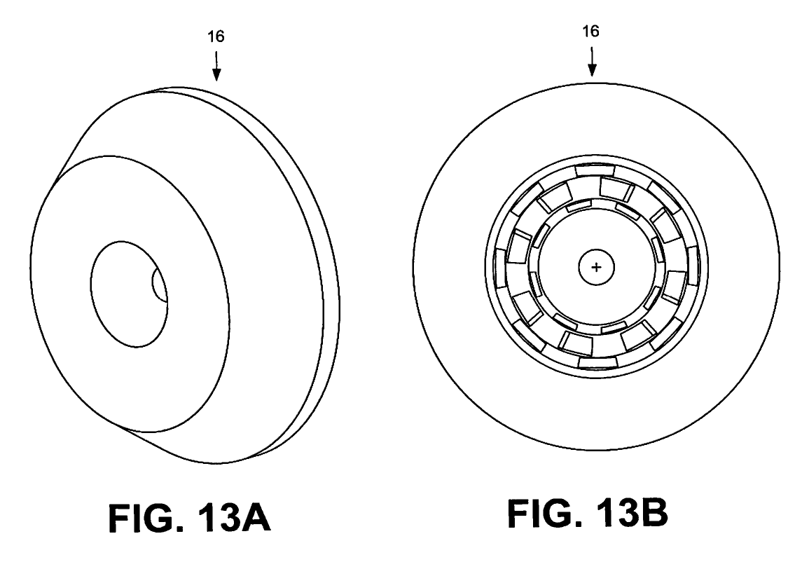

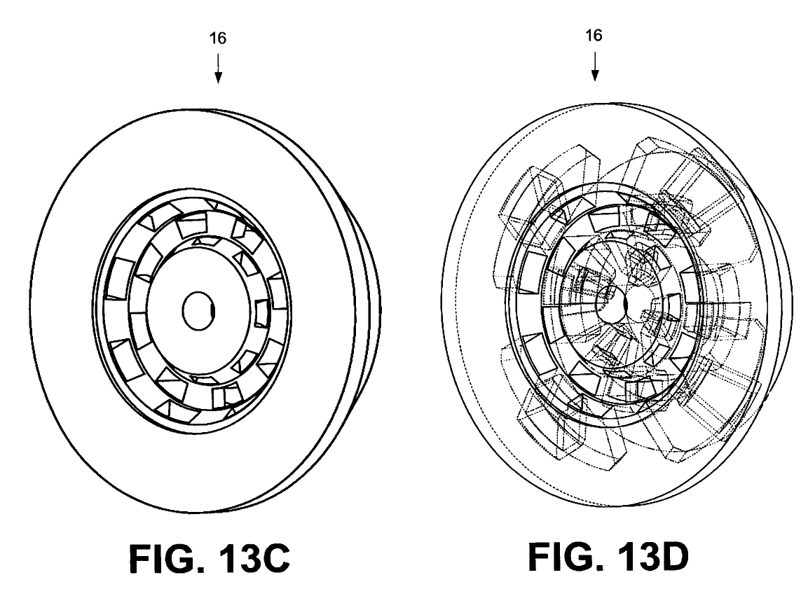

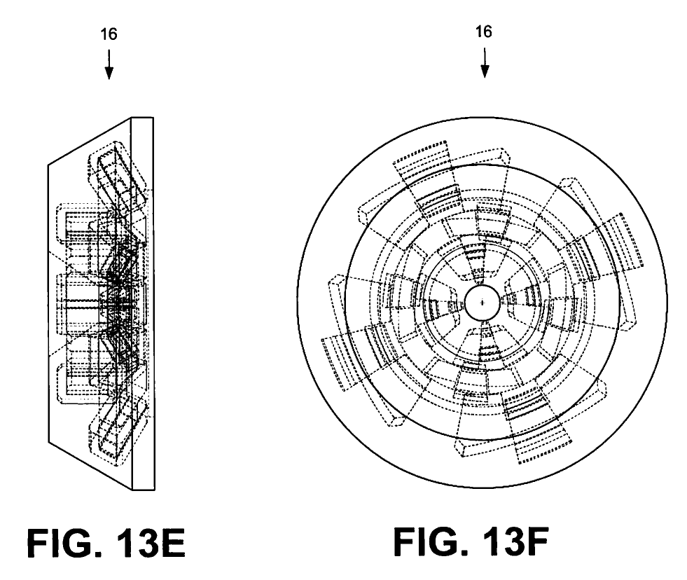

FIGS. 9A-9B and 10A-10B depict all three stator chuck arrangements 14a, 14b, 14c enclosing and surrounding a single rotor assembly 2 with partial overlapping of the arrangements. In a preferred embodiment, the stator chuck arrangements 14a, 14b, 14c are held in place by means integrated into a stator housing 16, a preferred embodiment of which is depicted in FIGS. 13A-13F. The stator housing 16 is not depicted in FIGS. 9A and 9B and 10A-10B so that the chuck arrangements 14a, 14b, 14c may be clearly shown.

Unlike a traditional SRM design, the preferred embodiment of the stator housing 16 is not part of the primary flux path or part of any electrical conduction path. Thus, the stator housing 16 need only provide mechanical integrity in supporting the stator chuck arrangements and maintaining their locations with respect to the rotor assembly 2. Preferably, wires or traces for connection of stator chuck windings as well as desired control elements are integrated into the stator housing 16. The housing 16 may be formed from practically any material that provides the desired structural rigidity, such as plastic, metal or composite materials.

As flux linkage of sufficient magnitude is established between any one of the stator chuck arrangements (such as 14a) and the rotor teeth 6, the rotor teeth 6 will tend to align with the flux established between the opposing chuck poles 10b in the stator chuck arrangement 14a. Since the rotor teeth 6 are secured to the rotor hub 4, the alignment of the teeth 6 to the chuck poles 10b causes the rotor hub 4 to rotate. As the hub 4 rotates, the teeth 6 begin to align with the poles 10b of an adjacent stator chuck arrangement 14b which is angularly and spatially offset from the chuck arrangement 14a. (See FIGS. 10A-10B.) The adjacent stator chuck arrangement 14b then begins to establish new flux linkages as the flux linkages for the previous chuck arrangement 14a peak and begin to decay. This process of flux establishment, alignment of rotor teeth 6 and chuck poles 10b, flux decay and new flux establishment is repeated for continuous rotation and operation. Stator chuck sets 12a-12b work cooperatively within the stator chuck arrangements 14a, 14b, 14c. In this way, flux linkage is made successively from one stator chuck arrangement to another. Since the stator chuck arrangements 14a, 14b, 14c are positioned angularly and spatially around the rotor teeth 6, flux linkage, and thus torque generation, is made along a three-dimensional path surrounding the rotor teeth 6.

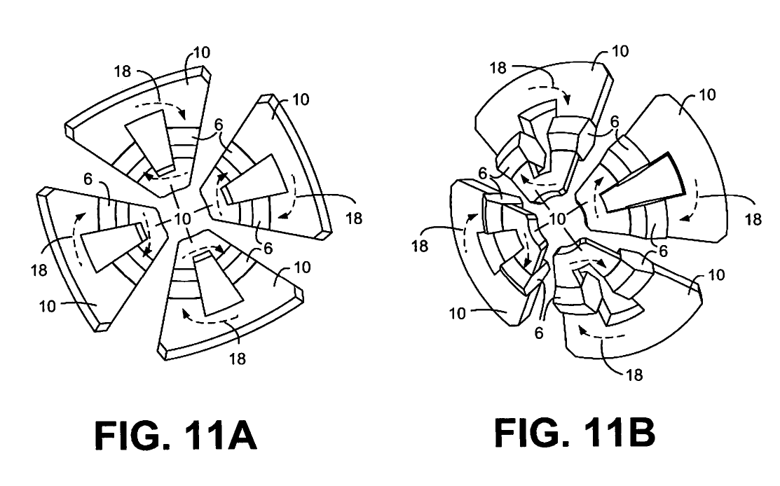

In an alternative embodiment of the invention, chuck arrangements 14a, 14b, 14c may have several different configurations. For example, FIGS. 11A and 11B show a “loop” configuration. In this configuration four separate flux paths 18 exist within each chuck arrangement 14 and the flux paths 18 are localized about four separate center points. In the configuration shown in FIGS. 11A and 11B, each flux path 18 involves two stator chucks 10 and two rotor teeth 6 per path. It will be appreciated that more or fewer than four flux paths per arrangement may exist in a loop configuration. Thus, the invention is not limited to any particular number of flux paths in a loop configuration.

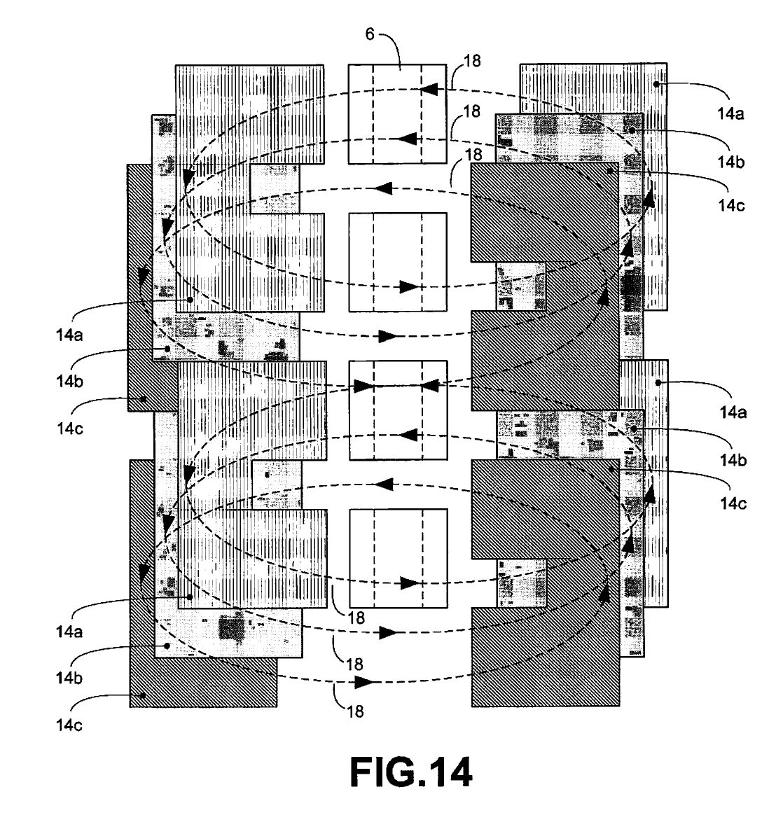

FIG. 14 depicts a plane view representation of the loop configuration showing the alignment pattern with partial overlapping and the multiple localized flux paths 18. Utilization of the loop configuration has advantages in applications requiring large load variations. With sufficient control capabilities, individual chuck set windings within an arrangement could be disengaged so that they no longer produce flux and thus torque. This allows other still operational chuck sets to continue operating at their peak efficiencies. With sufficient mechanical and control integration, the loop configuration also allows for the removal and replacement of a chuck set, possibly while the motor is still in operation. This ability to repair the motor without removal or total disassembly has significant advantages and benefits, such as maximized in-service time.

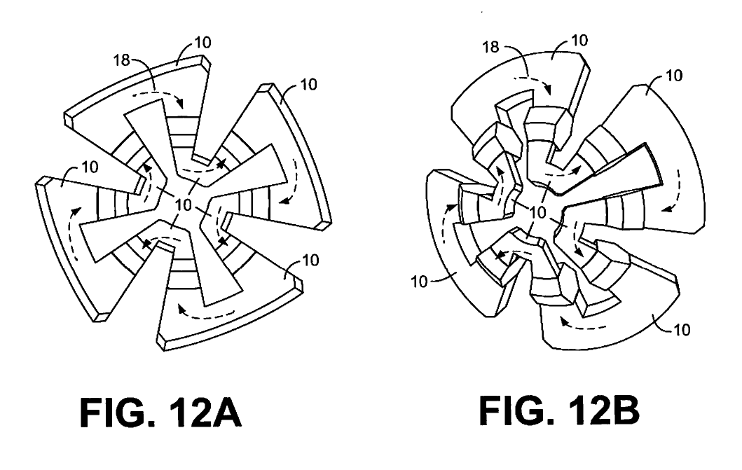

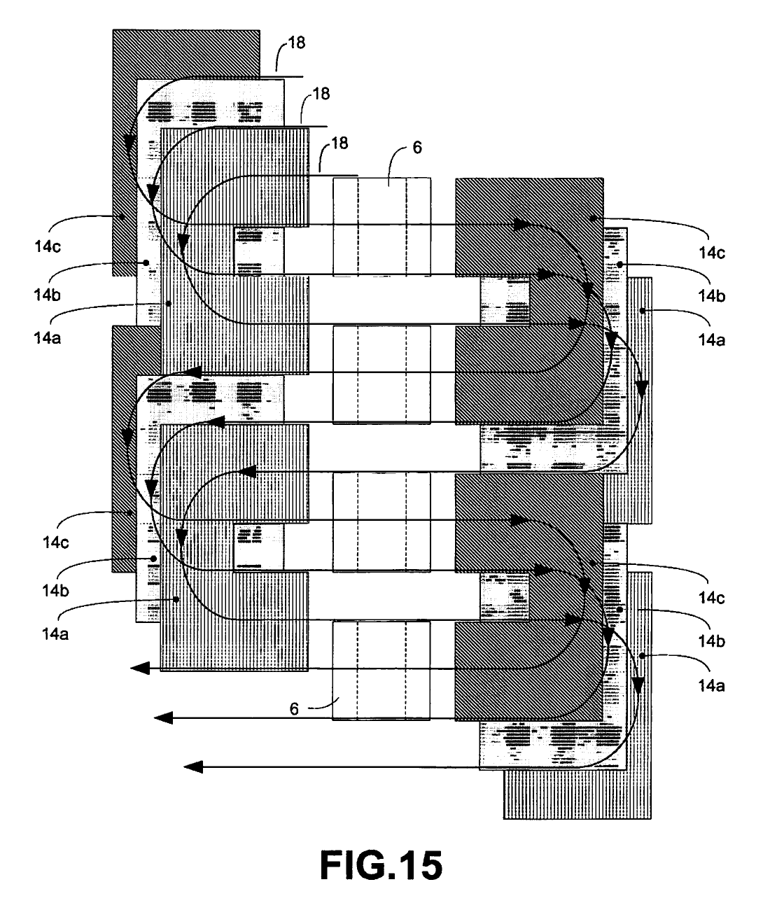

FIGS. 12A-12B show a coupled configuration in which the flux flows through a single primary flux path 18 passing through all the chucks 10 and all the rotor teeth 6. FIG. 15 depicts a plane view representation of the coupled configuration showing the alignment pattern with partial overlapping and the single flux path 18 per chuck arrangement. The coupled configuration is beneficial in applications with relatively constant loading. Because the flux within a coupled arrangement is in series, a failure of one winding would result in marginal loss to the overall arrangement. Thus, with sufficient controls the remaining windings would need only increase their current level a nominal amount to return to the desired flux linkage magnitude. This would delay the need for immediate repair thereby allowing the motor to say in service longer.

It will be appreciated that some embodiments of the invention may comprise a combination of the loop and coupled configurations.

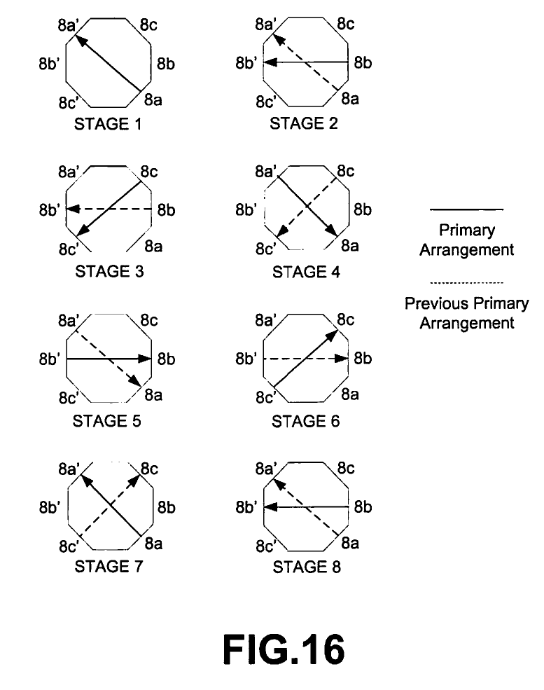

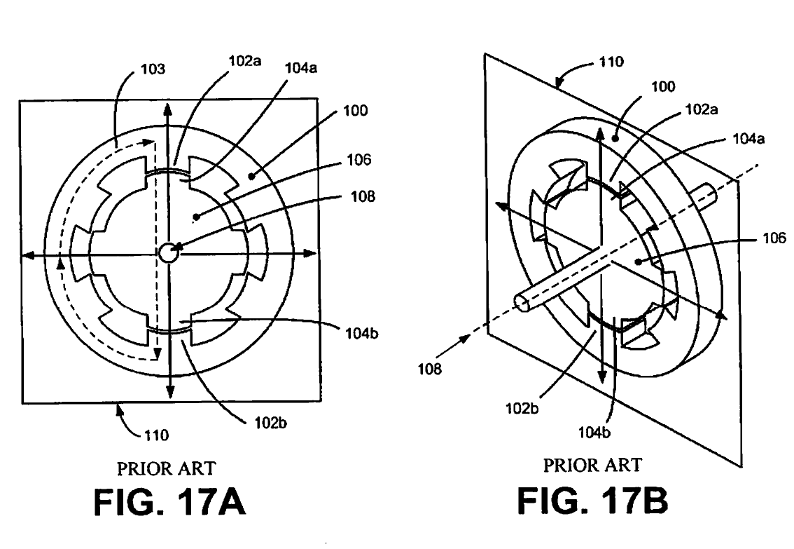

Many prior art schemes have a specific flux path passing within rotor teeth. However, the transverse nature of the flux paths of the present invention is such that the flux path through the rotor tooth is variable. Thus, the flux path may be in opposite directions for two different rotor positions or it may be angularly offset. For example, FIG. 16 depicts the sequential process of flux linkage initiation from one stator chuck arrangement to another during eight stages of operation of an SRM having three chuck arrangements. The arrows indicate the primary direction of the flux path within a stator tooth from one tooth face (such as 8a) to the opposing tooth face (such as 8a′). In the case of overlap of stator chuck arrangements, the previous chuck will have established flux linkage, such that any new flux linkage may result in significant mutual inductance. If there is little to no overlap, the previous primary arrangement may have little effect upon the developing linkages.

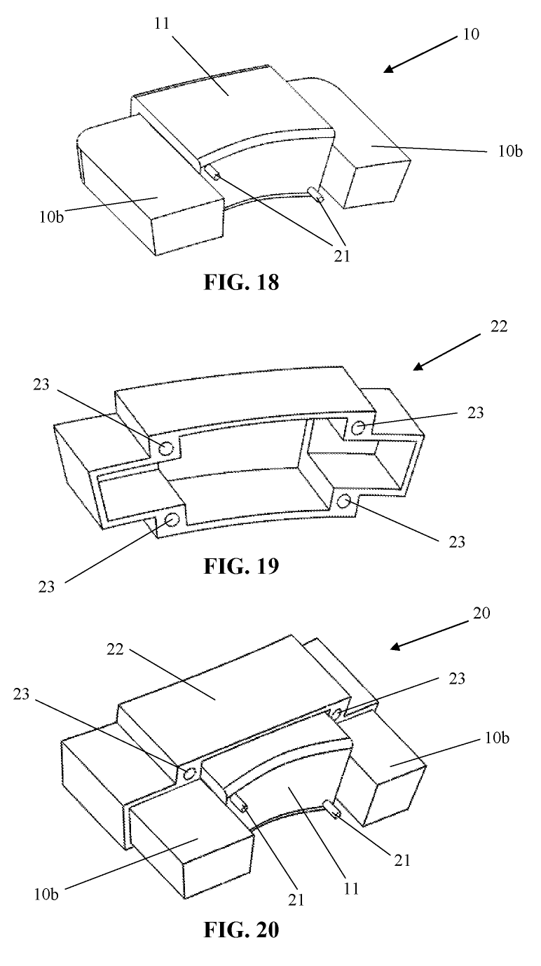

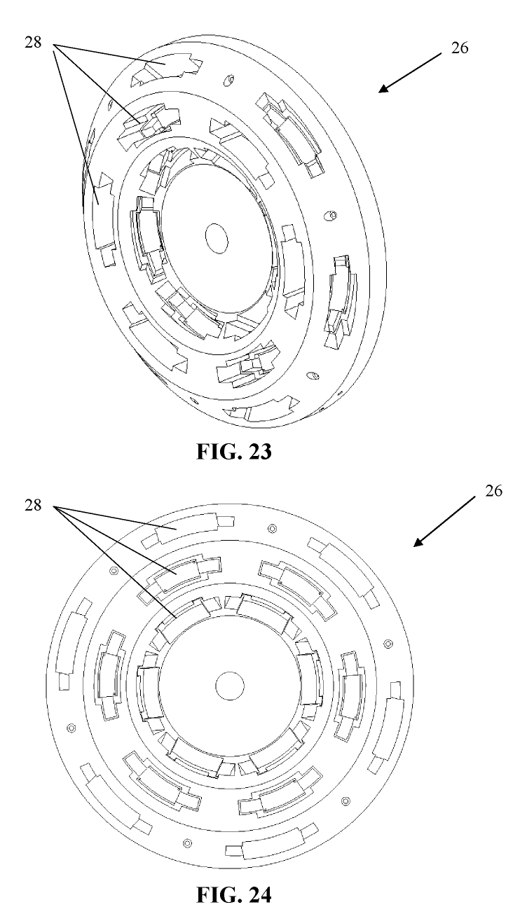

In some embodiments of the invention, such as depicted in FIGS. 18-26, the motor may be disassembled and repaired in-place without the use of any highly specialized tools or equipment. As shown in FIGS. 18-20, each of the stator chuck assemblies 20 include a stator chuck 10 having two chuck poles 10b and a chuck winding 11. The stator chuck assembly 20 may also include a chuck cartridge 22 for supporting the stator chuck 10 and allowing for the easy removal and replacement of the stator chuck 10 from the stator chuck assembly 20. The stator chuck 10 may be attached to the chuck cartridge 22 using latches, bolts, screws, adhesive or any suitable fastening means to secure the chuck poles 10b and chuck winding 11 of the stator chuck 10 to the chuck cartridge 22.

As shown in FIGS. 21-25, the stator chuck assemblies 20 are configured to be inserted into a plurality of slots 28 provided in a stator housing 26. The slots 28 support the stator chuck assemblies 20 in fixed positions relative to the rotor assembly 2 (FIGS. 1A-1C) so that the chuck poles 10b of each stator chuck assembly 20 are disposed adjacent the rotor teeth 6 as the rotor assembly 2 rotates about the rotational axis. The chuck assemblies 20 may be secured in the slots 28 of the stator housing 26 by passing bolts, screws or other suitable fasteners through holes 23 of the chuck cartridge 22 and into the stator housing 26. As shown in FIG. 22, when a chuck assembly 20 is fully inserted into a slot 28, the outer edge of the chuck cartridge 22 is preferably flush with the outer surface of the housing 26.

In preferred embodiments, each of the stator chuck assemblies 20 may be easily removed from the slots 28 of the stator housing 26 independently of each of the other stator chuck assemblies 20. In these embodiments, the stator housing 26 does not need to be part of the primary flux path or part of any electrical conduction path of the motor. The stator housing 26 only needs to provide structural integrity in supporting the stator chuck assemblies 20 and maintaining the locations of the stator chucks 10 with respect to the rotor assembly 2. Since the stator housing 26 is not in the motor's flux path, the stator housing 26 may be formed from practically any material that provides the desired structural rigidity, such as plastic, ceramic, foam, metal or composite materials.

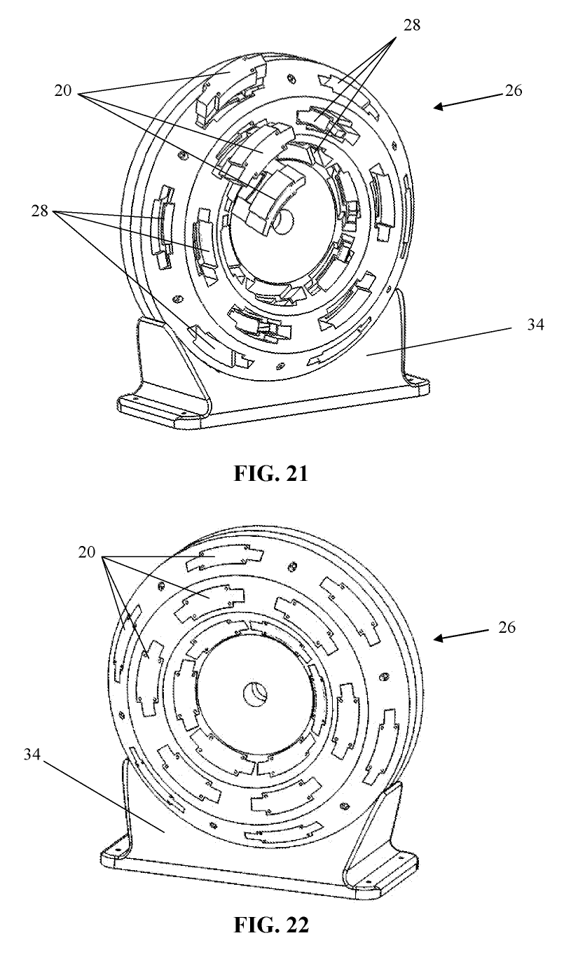

As shown in FIGS. 18 and 20, the chuck winding 11 of the stator chuck assembly 20 has electrical contact points 21 for electrically connecting the chuck winding 11 to other circuit points within the motor when the chuck assemblies 20 are inserted into the stator housing 26 slots 28. These contact points 21, along with interconnecting circuitry provided within the stator housing 26, provide a continuous current path for each motor phase when all of the chuck assemblies 20 are inserted into the slots 28 in the stator housing 26.

In preferred embodiments, each chuck assembly 20 includes sensor and control circuitry for monitoring the status and temperature of the chuck winding 11. The sensor and control circuitry may be used to provide an indication, such as a visual indication, of the operating status to a user. For example, a light may indicate that the chuck assembly 20 is not operating properly, or a numerical value displayed on a connected measurement/display device may identify certain specific problems. In some embodiments of the invention, the sensor and control circuitry is embedded in the stator housing 26. In other embodiments, sensors are provided in the housing 26 or chuck assemblies 20 and the monitoring and control circuitry is provided as part of an external motor drive circuit that is connected to the sensors via wiring paths provided through the housing 26.

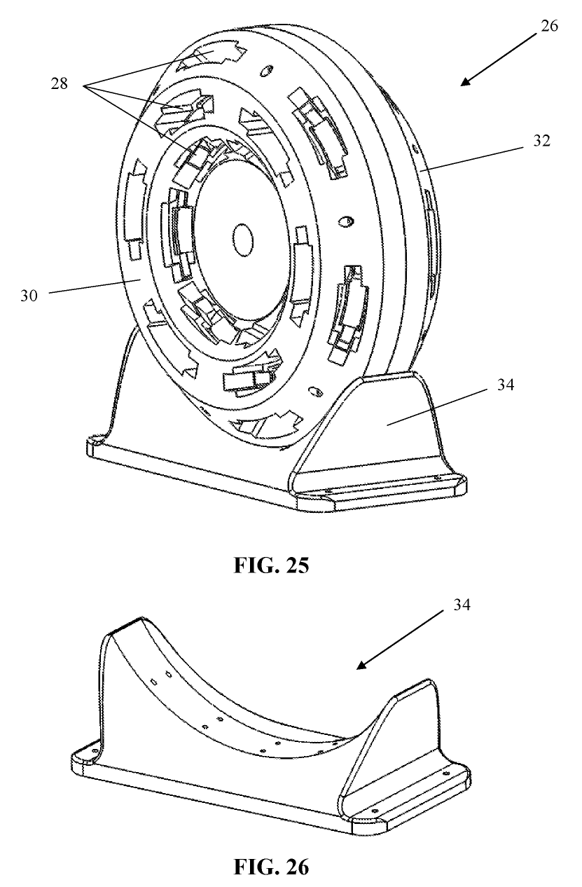

In preferred embodiments as depicted in FIG. 25, the stator housing 26 includes a first housing half 30 and a second housing half 32 that is separable from the first housing half 30. Preferably, the first and second housing halves 30 and 32 are substantially identically so that they may be interchangeable. Thus, the number of constituent parts of the motor is further reduced. The stator housing 26 may be attached to a base 34 as shown in FIGS. 21, 22, 25 and 26. The stator housing 26 may be attached to the base 34 using latches, bolts, screws or any suitable fastening means.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An electric machine having a rotational axis, the machine comprising:
a rotor assembly comprising:
a rotor hub disposed in a rotational plane that is substantially perpendicular to the rotational axis; and
a plurality of rotor teeth affixed to the rotor hub, the rotor teeth disposed in a substantially circular path about the rotational axis, the rotor teeth including at least a first rotor tooth and a second rotor tooth;
a plurality of stator chuck assemblies, each stator chuck assembly comprising a first chuck pole, a second chuck pole and a chuck winding, the plurality of stator chuck assemblies including at least a first stator chuck assembly and a second stator chuck assembly; and
a stator housing including a plurality of slots for receiving and supporting the stator chuck assemblies in fixed positions relative to the rotor assembly so that the first and second chuck poles of each stator chuck assembly are disposed adjacent the rotor teeth as the rotor assembly rotates about the rotational axis,
where during operation of the electric machine, a flux path passes from the first chuck pole of the first stator chuck assembly into the first rotor tooth, through the first rotor tooth and into the first chuck pole of the second stator chuck assembly, from the first chuck pole of the second stator chuck assembly to the second chuck pole of the second stator chuck assembly, and from the second chuck pole of the second stator chuck assembly into the second rotor tooth.

2. The electric machine of claim 1 wherein each of the stator chuck assemblies may be removed from and replaced in the stator housing slots independently of each of the other stator chuck assemblies.

3. The electric machine of claim 1 wherein the plurality of slots are disposed in an exterior surface of the stator housing.

4. The electric machine of claim 1 wherein the stator housing further comprises a first housing half and a second housing half that is separable from the first housing half.

5. The electric machine of claim 4 wherein the first housing half and the second housing half are substantially identical and interchangeable.

6. The electric machine of claim 1 wherein the stator housing is formed of a nonmetallic material.

7. The electric machine of claim 6 wherein the stator housing is formed of a nonmetallic material selected from the group consisting of plastic, ceramic, foam, and combinations thereof.

8. The electric machine of claim 1 wherein each stator chuck assembly further comprises a chuck cartridge for holding the first chuck pole, second chuck pole and chuck winding, wherein the chuck cartridge is removably received within a corresponding one of the slots in the stator housing.

9. The electric machine of claim 1 wherein each chuck assembly further comprises means for determining an operating status of the chuck assembly.

10. The electric machine of claim 1 wherein some or all of the chuck assemblies are substantially identical and interchangeable.

11. An electric machine having a rotational axis, the machine comprising:
a rotor assembly comprising a plurality of rotor teeth disposed in a substantially circular path about the rotational axis;
a plurality of substantially identical and interchangeable stator chuck assemblies disposed adjacent the rotor teeth as the rotor assembly rotates about the rotational axis; and
a stator housing for supporting the stator chucks assemblies in fixed positions relative to the rotor assembly,
whereby each of the stator chuck assemblies may be removed from the stator housing independently of each of the other stator chuck assemblies.

12. The electric machine of claim 11 wherein the stator housing includes a plurality of slots disposed in an exterior surface of the stator housing for receiving and supporting the stator chuck assemblies.

13. The electric machine of claim 11 wherein the stator housing further comprises a first housing half and a second housing half that is separable from the first housing half.

14. The electric machine of claim 13 wherein the first housing half and the second housing half are substantially identical and interchangeable.

15. The electric machine of claim 11 wherein the stator housing is formed of a nonmetallic material.

16. The electric machine of claim 15 wherein the stator housing is formed of a nonmetallic material selected from the group consisting of plastic, ceramic, foam, and combinations thereof.

17. The electric machine of claim 10 further comprising means for determining an operating status of the stator chuck assemblies, wherein one or more components of said means are located in one or more of the chuck assemblies, in the stator housing or in an external motor drive circuit.

18. The electric machine of claim 12 wherein each stator chuck assembly further comprises a pair of opposing chuck poles and a chuck winding disposed within a chuck cartridge which is removably received within a corresponding one of the slots in the stator housing.

19. The electric machine of claim 11 further comprising a base to which the stator housing is attached.
